(19) United States
(12) Patent Application Publication
(10) Pub. No.: US 2016/0026957 A1
(43) Pub. Date: Jan. 28, 2016

(54) SUPPLIER DESIGN INTEGRITY ANALYTICS ENGINE AND METHODOLOGY

(71) Applicant: International Business Machines Corporation, Armonk, NY (US)

(72) Inventors: Richard J. Fishbune, Rochester, MN (US); Justin Gilbert, Mabel, MN (US); Nadeem Malik, Austin, TX (US); Katherine J. Pearsall, Georgetown, TX (US)

(21) Appl. No.: 14/444,875

(22) Filed: Jul. 28, 2014

(51) Int. Cl. G06Q 10/06; G06Q 50/00

(52) U.S. Cl. CPC G06Q 10/06315; G06Q 10/0635; G06Q 50/01

(57) ABSTRACT

An apparatus includes a supplier ID module that identifies one or more suppliers that provide a component in a selection process that includes selecting suppliers to supply the component for use in a product made by a user. An existing product search module searches data sources available on the internet for the component or existing products that contain the component. A category module identifies one or more categories related to the component, where each category is related to risk assessment for the component and/or suppliers of the component. A component data search module searches data sources available on the internet for risk assessment information related to the component and/or existing products with the component. The information is relevant to the one or more categories and each item of risk assessment information identifies the supplier that provided the component. A categorization module categorizes the risk assessment information.

### FIELD

The subject matter disclosed herein relates to supplier selection and more particularly relates to supplier selection using data from social media another sources available on the internet.

### BACKGROUND

A typical product includes components from multiple suppliers. Often the components are complex systems and may include numerous parts from other suppliers. At each level if a quality program is not in place or if something happens to a supplier that affects quality or an ability to provide a desired amount of the supplier's product, then supplier problems often affect other suppliers and manufacturers that depend on the supplier's product.

Often suppliers are selected based on a traditional supplier selection process that includes information provided by the suppliers, including an ability to meet specifications, quality programs of the suppliers, statements with regard to an ability to provide a desired quantity of a component, etc. However, the traditional supplier selection process is often tainted by a built-in bias because much of the information used in the selection process is provided by the suppliers or from references selected by the suppliers. Information from suppliers may not include quality problems, past performance issues, and the like.

### BRIEF SUMMARY

An apparatus for supplier selection is disclosed. A method and a computer program product also perform the functions of the apparatus. The apparatus, in one embodiment, includes a supplier ID module that identifies, as part of a selection process, one or more suppliers that provide a component. The selection process includes a process to select one or more suppliers to supply the component for use in a product made by a user. The apparatus, in one example, includes an existing product search module that searches one or more data sources that are available on the internet for one or more existing products purchased by others that contain the component and/or include the component without other components. The existing products are different from the user's product. The apparatus, in one embodiment, includes a category module that identifies one or more categories related to the component, where each category is related to risk assessment for the component and/or a supplier of the component.

In one embodiment, the apparatus includes a component data search module that searches one or more data sources that are available on the internet for risk assessment information related to the component and/or existing products with the component and retrieves the risk assessment information. The information is relevant to the one or more categories, where each item of risk assessment information identifies the supplier that provided the component associated with the item of risk assessment information. The apparatus, in another embodiment, includes a categorization module that categorizes the retrieved risk assessment information in the one or more categories.

In one embodiment, the apparatus includes a risk update module that, for each of the one or more suppliers, updates supplier selection information associated with a supplier of the component based on the retrieved risk assessment information. In another embodiment, the supplier selection information is provided by a supplier selection module that compiles information about each supplier of the one or more suppliers and information about the component supplied by each supplier. The information about each supplier is relevant to selecting the supplier for providing the component, and the information about the component supplied by each supplier includes information relevant to selecting the supplier for providing the component.

In another embodiment, the supplier selection module also calculates a supplier selection score for each supplier of the one or more suppliers based on the information about each supplier and the information about the component supplied by each supplier, and the risk update module updates the supplier selection information by adjusting the supplier selection score of each supplier of the one or more suppliers based on the retrieved risk assessment information. In another embodiment, the information about each supplier and the information about each component may include information related to component reliability, information related compliance with a specification for the component, information related to supplier quality compliance, information related to supplier performance, and/or information related to an ability of the supplier to provide a desired quantity of the component.

In one embodiment, the apparatus includes a data update module that periodically initiates a search for new risk assessment information and retrieves the new risk assessment information where the risk update module, for each of the one or more suppliers, updates supplier selection information associated with a supplier of the component based on the new risk assessment information. In a further embodiment, the apparatus includes a supplier adjustment module that adjusts quantities of the component supplied by selected supplier based on the new risk assessment information and/or adjusts which suppliers of the one or more suppliers supply the component based on the new risk assessment information.

In one embodiment, the one or more categories include categories that facilitate comparison of the one or more suppliers. In another embodiment, the risk assessment information may include information about a product recall by a supplier of the one or more suppliers, where the recall is for a product by the supplier that involves the component, information about defects of the component, information about performance of a supplier of the one or more suppliers, information related to health of a supplier of the one or more suppliers, information related to customer service of a supplier of the one or more suppliers, information related to customer satisfaction regarding the component provided by a supplier of the one or more suppliers and/or an existing product that includes the component, where the existing product is provided by a supplier of the one or more suppliers, and/or information related to one or more of political instability and a natural disaster that may affect a supplier of the one or more suppliers.

In one embodiment, the component data search module retrieves risk assessment information from one or more social media websites. In another embodiment, the component data search module uses a web crawler to search information available on the internet. In another embodiment, the component data search module submits, to one or more search engines, one or more search strings to search information available on the internet, where the search engines retrieve the risk assessment information based on previously indexed data. In another embodiment, each of the one or more suppliers provides a version of the component that complies with one or more component specifications. In another embodiment, the component data search module receives one or more alerts regarding the component, wherein the one or more alerts comprise risk assessment information.

A method for supplier selection includes, in one embodiment, identifying, using a supplier ID module and as part of a selection process, one or more suppliers that provide a component. The selection process includes a process to select one or more suppliers to supply the component for use in a product made by a user. The method, in another embodiment, includes searching, using an existing product search module, one or more data sources that are available on the internet for one or more existing products purchased by others that contain the component and/or include the component without other components, where the existing products differ from the user's product. The method, in another embodiment, includes identifying, using a category module, one or more categories related to the component, where each category is related to risk assessment for the component and/or a supplier of the component. The method, in another embodiment, includes searching, using a component data search module, one or more data sources that are available on the internet for risk assessment information related to the component and/or existing products with the component, and retrieving the risk assessment information. The information is relevant to the one or more categories where each item of risk assessment information identifies the supplier that provided the component associated with the item of risk assessment information. The method, in one embodiment, includes categorizing, using a categorization module, the retrieved risk assessment information in the one or more categories.

In one embodiment, the method includes compiling, using a supplier selection module, information about each supplier of the one or more suppliers and information about the component supplied by each supplier. The information about each supplier is relevant to selecting the supplier for providing the component and the information about the component supplied by each supplier includes information relevant to selecting the supplier for providing the component. The method may also include updating, using a risk update module and for each of the one or more suppliers, the supplier selection information associated with a supplier of the component based on the retrieved risk assessment information.

In another embodiment, the method includes calculating, using the supplier selection module, a supplier selection score for each supplier of the one or more suppliers based on the information about each supplier and the information about the component supplied by each supplier. Updating the supplier selection information associated with a supplier of the component based on the retrieved risk assessment information includes adjusting the supplier selection score of each supplier of the one or more suppliers based on the retrieved risk assessment information. In another embodiment, the method includes periodically initiating, using a data update module, a search for new risk assessment information and retrieving the new risk assessment information. The method may further include updating, using the risk update module and for each of the one or more suppliers, supplier selection information associated with a supplier of the component based on the new risk assessment information. In another embodiment, the one or more data sources that are available on the internet for risk assessment information include one or more social media websites.

A computer program product for supplier risk assessment is disclosed. The computer program product includes a computer readable storage medium having program instructions embodied therewith. The program instructions are readable/executable by a processor to cause the processor to identify, using a processor and as part of a selection process, one or more suppliers that provide a component. The selection process includes a process to select one or more suppliers to supply the component for use in a product made by a user. The program instructions are readable/executable by the processor to cause the processor to search one or more data sources that are available on the internet for one or more existing products purchased by others that one or more of contain the component and comprise the component without other components, where the existing products differ from the user's product. The program instructions are readable/executable by a processor to cause the processor to identify one or more categories related to the component, where each category is related to risk assessment for one or more of the component and a supplier of the component.

The program instructions are readable/executable by a processor to cause the processor to search one or more data sources that are available on the internet for risk assessment information related to the component and/or existing products with the component and to retrieve the risk assessment information, where the information is relevant to the one or more categories and where each item of risk assessment information identifies the supplier that provided the component associated with the item of risk assessment information. The program instructions are readable/executable by a processor to cause the processor to categorize the retrieved risk assessment information in the one or more categories.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for supplier selection in accordance with one embodiment of the present invention;

FIG. 2 is a schematic block diagram illustrating one embodiment of an apparatus for supplier selection in accordance with one embodiment of the present invention;

FIG. 3 is a schematic block diagram illustrating another embodiment of an apparatus for supplier selection in accordance with one embodiment of the present invention;

FIG. 4 is a schematic flow chart diagram illustrating one embodiment of a method for supplier selection in accordance with one embodiment of the present invention; and

FIG. 5 is a schematic flow chart diagram illustrating another embodiment of a method for supplier selection in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. The description of elements in each figure may refer to elements of proceeding figures. Like numbers refer to like elements in all figures, including alternate embodiments of like elements.

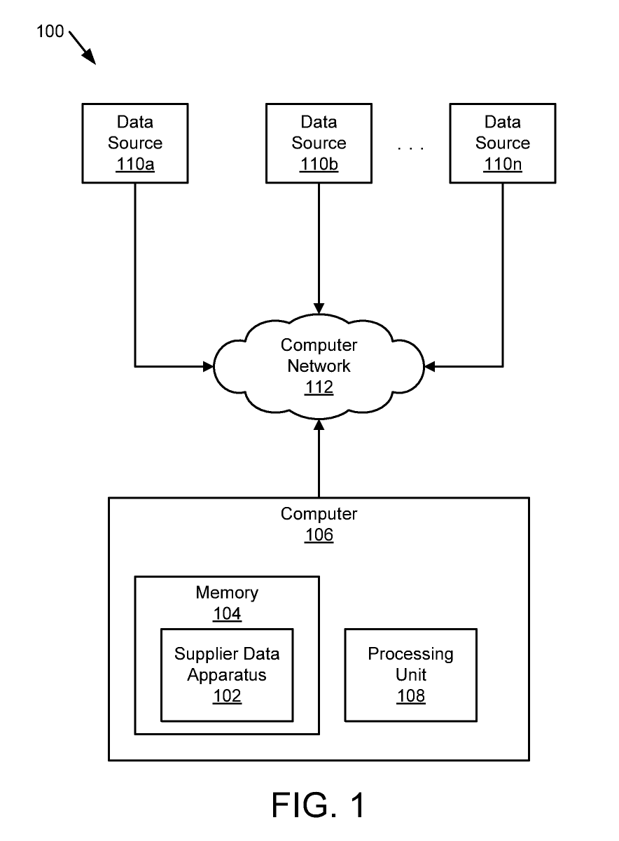

FIG. 1 is a schematic block diagram illustrating one embodiment of a system 100 for supplier selection in accordance with one embodiment of the present invention. The system 100 includes a supplier data apparatus 102, memory 104, a computer 106, a processing unit 108, data sources 110a-n (collectively or individually “110”), and a computer network 112, which are described below.

The system 100, in one embodiment, includes a supplier data apparatus 102 that searches one or more data sources for suppliers of a component and risk assessment information regarding the component available from the suppliers to assist in determining which supplier will provide the component. The component is typically used in a product and can be a single device, such as a resistor, a transistor switch, a valve, etc., or may be a component that includes multiple devices. For example, the component may be a semiconductor device that meets certain specifications where the component is available from different suppliers. In another embodiment, the component may be a system with multiple devices working together to meet a specification. For example, the component may be a power supply that meets certain specifications. Several suppliers may supply a power supply that meets the specifications. The power supply may include one or more systems and typically has numerous parts, such as resistors, capacitors, inductors, semiconductor switches, integrated circuits, etc., where each part will have to meet certain requirements and may be supplied by other suppliers.

In one embodiment, a component available from multiple suppliers is different for each supplier but meets a common set of specifications and/or requirements. For example, if the component is a power supply, one supplier may supply a switching power supply that has a certain direct current (“DC”)-to-DC converter topology while another supplier supplies a power supply with a different DC-to-DC converter topology while both power supplies meet a common set of specifications. In another embodiment, the component may be substantially the same from different suppliers but parts for the power supplies may be from different suppliers. In another embodiment, the components may be the same from the various suppliers but are from different manufacturers. For example, if the component is a semiconductor switch, each supplier may have a different manufacturer and the manufacturers may have differing quality standards and practices.

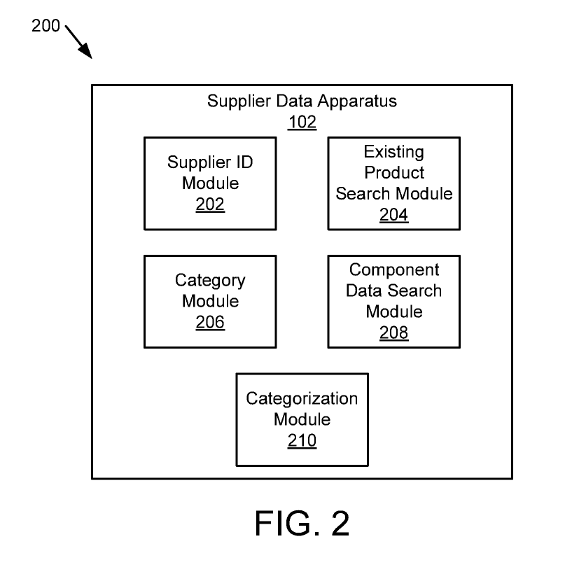

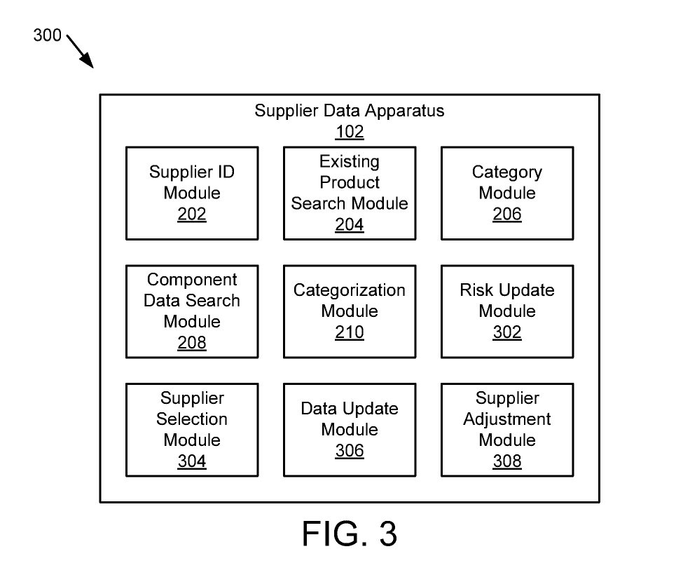

In general the supplier data apparatus 102 identifies suppliers that supply the component and have supplied others with the component and identifies categories applicable to the component and suitable for comparing the suppliers. The supplier data apparatus 102 then searches one or more data locations, some of which may be available on the internet, for risk assessment information regarding the components supplied to others by the various suppliers. The supplier data apparatus 102 may then place the risk assessment information into categories for comparison. The risk assessment information may be used to adjust supplier selection information and/or scores. For example, a supplier might have a high score based on information provided by the supplier but the risk assessment information may reduce the score and another supplier may be a better choice. The supplier data apparatus 102 will be discussed further with respect to the apparatuses 200, 300 of FIGS. 2 and 3.

The system 100 may include memory 104 and, in one embodiment, the supplier data apparatus 102 is located in the memory 104. For example, the supplier data apparatus 102 may include executable code stored on one or more computer readable storage media. The memory may be random access memory (“RAM”), solid-state non-volatile memory, a hard disk drive (“HDD”), an optical drive, cloud storage, a storage area network (“SAN”), or other computer readable storage media capable of storing the supplier data apparatus 102. The memory 104 may reside in the computer 106 as depicted in FIG. 1 or may be external to the computer 106 and may be accessible to the computer 106. In various embodiments, the supplier data apparatus 102 may be together as depicted in FIG. 1 or may have some modules or portions in different locations.

The computer 106 may be a server, mainframe computer, a workstation, a desktop computer, a laptop computer or the like. The computer 106 is depicted as one device in FIG. 1, but may include other components, such as storage devices, one or more displays, or may be part of a distributed computing environment. In one embodiment, the computer 106 is a dedicated device configured specifically for the supplier data apparatus 102 and may include dedicated logic hardware, a field programmable logic array (“FPGA”), etc. The computer 106 may include one or more processing units 108, such as a single processor, a multi-core processor, multiple processors on different motherboards, etc. For example, the computer 106 may include a mainframe with multiple processors capable of executing multiple virtual machines. One of skill in the art will recognize other configurations of one or more computing devices and associated devices capable of incorporating the supplier data apparatus 102.

The system 100, in one embodiment, includes one or more data sources 110 accessible to the computer 106 over a computer network 112. The data sources 110 may include one or more computers, servers, computer readable storage devices, etc. The data sources 110 include information about a component from various suppliers where the information is available to the supplier data apparatus 102. In one embodiment, the computer network 112 includes the internet and the data sources 110 include one or more websites or other data storage locations accessible over the internet. The computer network 112 may also include a local area network (“LAN”), a wireless network such as a WiFi network, a storage area network (“SAN”), and the like. The data sources 110 may include one or more social networks, blogs, bulletin boards, government sponsored websites regarding recalls and compliance with standards, etc. where regulators, customers and suppliers communicate information about a component supplied by the suppliers.

FIG. 2 is a schematic block diagram illustrating one embodiment of an apparatus 200 for supplier selection in accordance with one embodiment of the present invention. The apparatus 200 includes one embodiment of a supplier data apparatus 102 with a supplier ID module 202, an existing product search module 204, a category module 206, a component data search module 208, and a categorization module 210, which are described below.

In one embodiment, the apparatus 200 includes a supplier ID module 202 that identifies, as part of a selection process, one or more suppliers that provide a component. The selection process includes a process to select one or more suppliers to supply the component for use in a product made by a user. For example, the supplier ID module 202 may identify suppliers that supply a component that meets certain specifications. The supplier ID module 202 may identify suppliers that provide a pump assembly that meets certain requirements. In one embodiment, the supplier ID module 202 initiates a search for suppliers that supply the component. In another embodiment, the supplier ID module 202 sends out a request for information from suppliers and receives information from suppliers that wish to supply the component. In another embodiment, a user inputs one or more suppliers and the supplier ID module 202 compiles a list of the suppliers. A supplier may be a company that manufactures and sells the component, a distributor, a retailer, or any company capable of supplying the component.

The apparatus 200, in one embodiment, includes an existing product search module 204 that searches one or more data sources 110 for one or more existing products purchased by others that contain the component and/or include the component without other components. In one embodiment, one or more of the data sources 110 are available on the internet. The existing products typically differ from the user's product. For example, the existing products are those that have been sold previously to others by the suppliers. In one example, if the component is a power supply for a computer to be made by the user, the one or more suppliers may have sold computers with power supplies similar to those that are sought by the user. In another example, the suppliers may sell the power supplies directly to consumers, computer manufacturers, etc. and the existing product search module 204 may identify the power supplies sold by the suppliers. In one instance, the existing product search module 204 identifies information about the components sold by the suppliers. For example, the existing product search module 204 may identify one or more part numbers, model numbers, etc. associated with the components supplied by the one or more suppliers.

In one embodiment, the existing product search module 204 identifies exiting products with a component in a same class as the component sought by the user. For example, the suppliers may supply various types of power supplies and the existing product search module 204 may gather information about exiting products that include a power supply by a supplier, model numbers of power supplies of a supplier, etc. even if the power supplies meet different specifications than the component sought by the user. In one embodiment, the existing product search module 204 identifies existing products with similar components as well as similar components of the component sought by the user where information about the existing products and similar components may influence a decision to select a supplier.

The apparatus 200, in one embodiment, includes a category module 206 that identifies one or more categories related to the component. Each category is related to risk assessment for the component and/or a supplier of the component. The one or more categories are typically categories that may be useful in comparing one supplier with another supplier. For example, categories useful for comparing suppliers might include quality, reliability, field issues, warranty issues, general performance, etc. Quality information might include recall data, suppliers providing parts to a supplier having quality issues, etc. Reliability data might include information about recalls involving an existing product with the component, part failures, etc. Warranty information may include how well a supplier responds to warranty issues, type of warranty, complaints about a supplier warranty, etc. The categories may include general categories that may be related to the component as well the supplier and may be used to group data gathered from the data sources 110.

The apparatus 200, in one embodiment, includes a component data search module 208 that searches one or more data sources 110 for risk assessment information related to the component and/or existing products with the component and that retrieves the risk assessment information. In one embodiment, the data sources 110 are available on the internet. The information is relevant to the one or more categories and is typically useful in comparing the suppliers. Risk assessment information may include any information relevant for choosing a supplier, such as information regarding a component supplied by a supplier, information about customer service of the supplier, company health of the supplier (i.e. debt problems, management problems, etc.). Each item of risk assessment information identifies the supplier that provided the component associated with the item of risk assessment information.

The component data search module 208 is advantageous because the component data search module 208 searches so-called “big data” to identify and retrieve information that is available regarding the component and suppliers that would not normally be available in a traditional supplier selection process. A traditional supplier selection process may seek information from potential suppliers, from clients of potential suppliers, etc. and may include some bias based on the sources. Searching the internet and other data sources 110 that have component and supplier information may identify information that is not usually available in a traditional supplier selection process.

In one embodiment, the component data search module 208 searches social media websites for risk assessment information. Social media websites are becoming increasingly popular and often offer a venue for customers to vent complaints, for companies to communicate with customers, etc. In various embodiments, the component data search module 208 may search blogs, press releases, supplier publications, supplier recall notices, customer reviews, government websites of agencies that may regulate suppliers, and the like.

Often customer reviews include a common thread that may be useful in risk assessment. For example, if the component is a power supply for computers, several customer reviews of a computer may mention that the power supply failed in the computer, that the power supply ran hot, consumed too much power, etc., which may be valuable in selecting a supplier of power supplies. The risk assessment information may include information about a product recall by a supplier where the recall may be for a product by the supplier that involves the component. Product recalls may indicate a trend or a quality issue. Social media sites may include information about how customers seeking warranty repairs were treated by a particular supplier. The customers seeking warranty service may express concerns that might not be made available to the user by the supplier during a traditional supplier selection process.

In one example, the risk assessment information includes information about defects of the component. For example, the supplier may publish defect data or defect data may be identified by customers. In another example, the risk assessment information includes information about performance of a supplier of the one or more suppliers. For example, the component data search module 208 may find information that discusses late delivery of products with or without the component. In another example, the component data search module 208 retrieves customer satisfaction information regarding the component provided by a supplier and/or an existing product that includes the component. For example, a website may provide a customer satisfaction score based on customer reviews. In another example, the component data search module 208 retrieves information related to political instability in a country associated with a supplier, a natural disaster that may affect a supplier, etc. One of skill in the art will recognize other risk assessment data that the component data search module 208 may identify and retrieve.

In one embodiment, the component data search module 208 uses a web crawler to search information available on the internet. The web crawler may systematically search websites in search of risk assessment data related to the component and/or existing products with the component and the associated suppliers. The web crawler typically searches in a systematic way to search a website, to search each webpage available through the website, then to search another website, each webpage with the other website, etc. and may traverse a large segment of the internet. In one embodiment, the web crawler is limited by a search string, limited to certain domains, etc. In another embodiment, the web crawler searches continuously or at a periodic interval and may search without user direction after commencing the search.

In another embodiment, the component data search module 208 submits, to one or more search engines, one or more search strings to search information available on the internet. For example, the component data search module 208 may submit a search string based on information from the supplier ID module 202 and/or the existing product search module 204 where the search string may identify one or more suppliers, existing products with the component, model numbers, part numbers, etc. and a search engine may return risk assessment information to the component data search module 208. Typically, a search engines retrieve the risk assessment information based on previously indexed data. For example, the search engine may use a web crawler to index data from websites available to the search engine.

In another embodiment, the component data search module 208 receives one or more alerts regarding the component, where the one or more alerts include risk assessment information. For example, the component data search module 208 may initiate an alert from a website that may be triggered when certain risk assessment information becomes available. The component data search module 208 may monitor certain websites for new risk assessment information and/or alerts. One of skill in the art will recognize other ways that the component data search module 208 may search for and retrieve risk assessment information related to the component and/or existing products with the component.

The apparatus 200, in one embodiment, includes a categorization module 210 that categorizes the retrieved risk assessment information in the one or more categories. For example, if the component data search module 208 identifies information regarding a component recall, the categorization module 210 may place the component recall information in a quality category. In one embodiment, the categorization module 210 places some information in a miscellaneous category where another category may not be appropriate. In one example, the categorization module 210 presents risk assessment information and categories to a user and assists the user in linking the risk assessment information to a category. In one embodiment, information in one category may be weighted differently than information in another category. For example, information from a government sponsored website regarding product recalls in a recall category may be weighted more heavily than information in a social media category that includes customer reviews. In another embodiment, the categorization module 210 automatically places risk assessment information in one or more categories.

FIG. 3 is a schematic block diagram illustrating one embodiment of another apparatus 300 for supplier selection in accordance with one embodiment of the present invention. The apparatus 300 includes another embodiment of the supplier data apparatus 102 with a supplier ID module 202, an existing product search module 204, a category module 206, a component data search module 208, and a categorization module 210, which are substantially similar to those described above in relation to the apparatus 200 of FIG. 2. In other embodiments, the apparatus 300 may include a risk update module 302, a supplier selection module 304, a data update module 306, and a supplier adjustment module 308, which are described below.

The apparatus 300, in one embodiment, includes a risk update module 302 that, for each of the one or more suppliers, updates supplier selection information associated with a supplier of the component based on the retrieved risk assessment information. In another embodiment, the supplier selection information is provided by a supplier selection module 304 that compiles information about each supplier of the one or more suppliers and information about the component supplied by each supplier. The information about each supplier is typically relevant to selecting the supplier for providing the component. The information about the component supplied by each supplier typically includes information relevant to selecting the supplier for providing the component. The supplier selection module 304, in one embodiment, may receive information provided by a supplier regarding a component that the supplier proposes supplying to the user and may also receive other information gathered during a typical supplier selection process. For example, the supplier selection module 304 may receive information from references identified by a supplier or may receive information from the user, such as user evaluation information regarding a supplier.

In one embodiment, the supplier selection module 304 calculates a supplier selection score for each supplier based on the information about each supplier and the information about the component supplied by each supplier. The risk update module 302 may then update the supplier selection information by adjusting the supplier selection score of each supplier based on the retrieved risk assessment information. Typically the retrieved risk assessment information is information not gathered during a typical supplier selection process but may affect the supplier selection process.

For example, the supplier selection module 304 may compile information about supplier A, supplier B and supplier C using a standard supplier selection process. The information about each supplier may include information related to component reliability, compliance with a specification for the component, supplier quality programs and quality compliance, supplier performance, ability of the supplier to provide a desired quantity of the component, etc. The supplier selection module 304 may calculate a supplier selection score where supplier A has a score of 86, supplier B has a score of 72 and supplier C has a score of 78. After the component data search module 208 has gathered information about existing products sold by suppliers A, B, and C where the existing products include a version of the component, supplier A is found to have defective components supplied in existing products and supplier C is found not to have conducted proper testing on a primary assembly of a component supplied in existing products. The risk update module 302 may discount the supplier selection score of supplier A by 15 points and the supplier selection score of supplier B by 10 points so the resulting score of supplier A is 71, the score of supplier B remains at 72, and the resulting score of supplier C is 68 so supplier B is selected to supply the component.

In one embodiment, the apparatus 300 includes a data update module 306 that periodically initiates a search for new risk assessment information and retrieves the new risk assessment information where the risk update module 302, for each supplier, updates supplier selection information associated with a supplier of the component based on the new risk assessment information. For example, the data update module 306 may initiate a new search on a daily basis, a weekly basis, a monthly basis or some other convenient time period and the component data search module 208 may then search for new risk assessment information about one or more current suppliers and/or potential suppliers and the risk update module 302 may update supplier selection information and/or a supplier selection score based on new risk assessment information. In another embodiment, the data update module 306 monitors one or more data sources 110 for updated risk assessment information about the component or existing products with the component and retrieves new risk assessment information as it becomes available.

In another embodiment, the apparatus 300 include a supplier adjustment module 308 that adjusts quantities of the component supplied by selected supplier based on the new risk assessment information and/or adjusts which suppliers of the one or more suppliers supply the component based on the new risk assessment information. For example, if supplier X is supplying 60% of the total components received by the user, supplier Y supplies 30% and supplier Z supplies 10% and new risk assessment data about supplier X indicates increased risk in supplying the component, the supplier adjustment module 308 may suggest adjusting quantities supplied by suppliers X, Y and Z so that supplier X supplies less than 60% of the component. In another embodiment, if supplier P supplies 50% and supplier Q supplies 50% of the component and new risk assessment information indicates that political unrest in the country of supplier P may affect supply from supplier P, the supplier adjustment module 308 may suggest that the amount of the product supplied by supplier P be reduced to 25% and that 25% be supplied by supplier R. One of skill in the art will recognize other ways that the supplier adjustment module 308 may use new risk assessment information from the data update module 306 to adjust amounts of the components supplied by one or more suppliers.

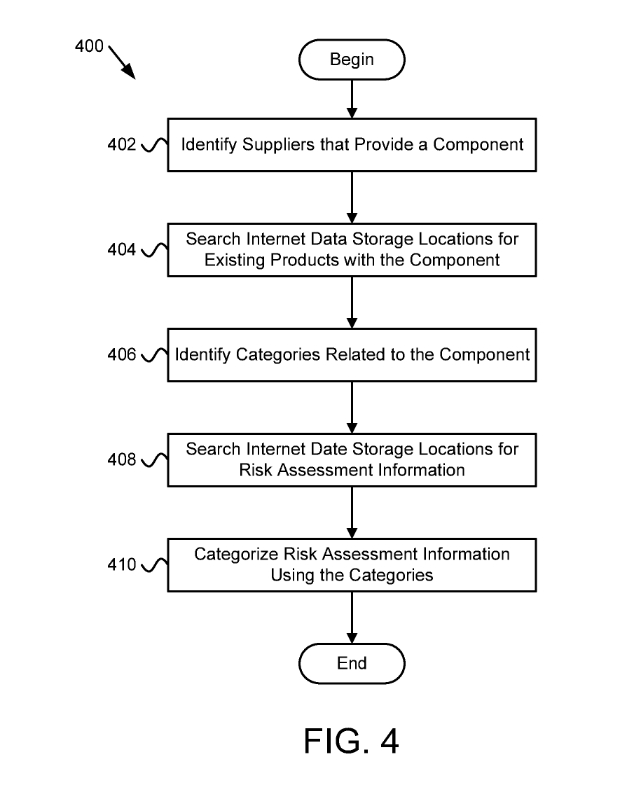

FIG. 4 is a schematic flow chart diagram illustrating one embodiment of a method 400 for supplier selection in accordance with one embodiment of the present invention. The method 400 begins and identifies 402, as part of a selection process, one or more suppliers that provide a component. The selection process includes a process to select one or more suppliers to supply the component for use in a product made by a user. In one embodiment, the supplier ID module 202 identifies 402 suppliers. The method 400 searches 404 one or more data sources 110 that are available on the internet for one or more existing products purchased by others that contain the component and/or include the component without other components. In one embodiment, the existing product search module 204 searches for the existing products.

The method 400 identifies 406 one or more categories related to the component where each category is related to risk assessment for the component and/or a supplier of the component. The category module 206 may identify 406 the categories. The method 400 searches 408 one or more data sources 110 that are available on the internet for risk assessment information related to the component and/or existing products with the component and retrieves the risk assessment information. Each item of risk assessment information typically correlates to the supplier that provided the component. The component data search module 208, in one embodiment, searches 408 and retrieves the risk assessment information. The method 400 categorizes 410 the retrieved risk assessment information in the one or more categories, and the method 400 ends. In one embodiment, the categorization module 210 categorizes 410 the risk assessment information.

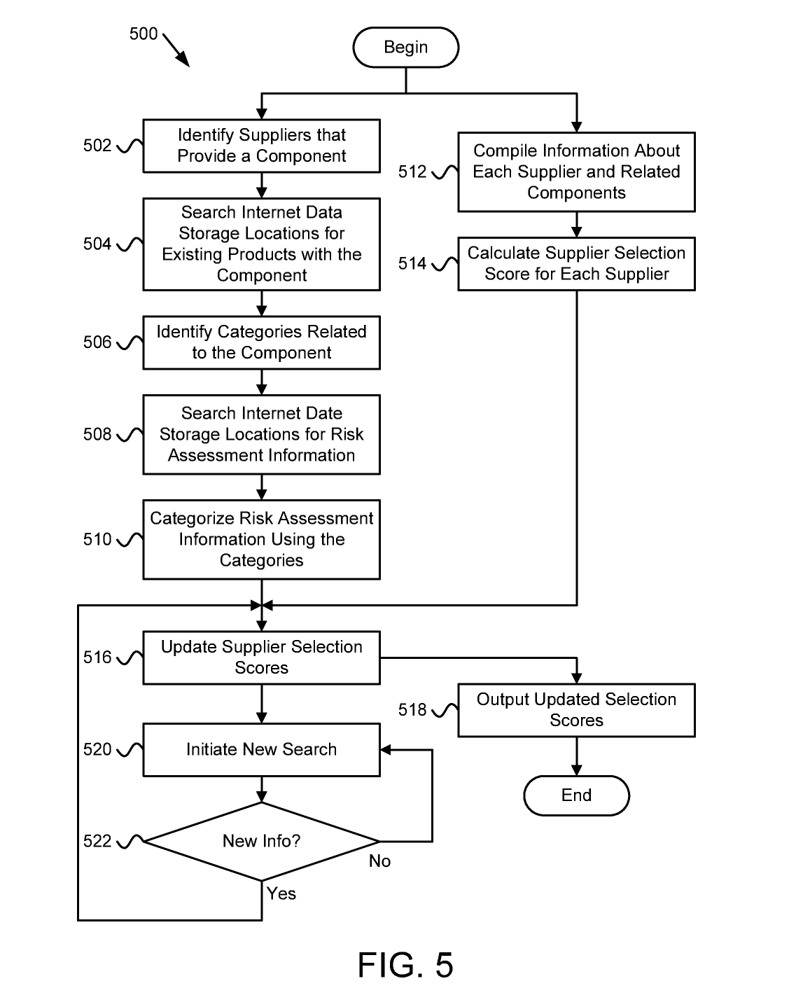

FIG. 5 is a schematic flow chart diagram illustrating one embodiment of another method 500 for supplier selection in accordance with one embodiment of the present invention. The method 500 begins and identifies 502, as part of a selection process, one or more suppliers that provide a component and searches 504 one or more data sources 110 that are available on the internet for one or more existing products purchased by others that contain the component and/or include the component without other components. The method 500 identifies 506 one or more categories related to the component, where each category is related to risk assessment for the component and/or a supplier of the component, and searches 508 one or more data sources 110 that are available on the internet for risk assessment information related to the component and/or existing products with the component and retrieves the risk assessment information. Each item of risk assessment information typically correlates to the supplier that provided the component. The method 400 categorizes 410 the retrieved risk assessment information in the one or more categories.

While the method 500 is executing steps 502-510, the method 500 compiles 512 compiles information about each supplier and information about the component supplied by each supplier and calculates 514 a supplier selection score for each supplier. The compiled information is typically received from a typical supplier selection process and the information is relevant to selecting the supplier for providing the component. Compiling 512 the information about each supplier and the component supplied by each supplier as well as calculating 514 a supplier selection score for each supplier may occur before, during or after steps 502-510. In various embodiments, the supplier selection module 304 compiles 512 the information and calculates 514 the supplier selection score for each supplier.

The method 500 updates 516 the supplier selection scores based on the risk assessment information. The method 500 periodically initiates 520 a new search for new risk assessment information and determines 522 if new risk assessment information is available. If the method 500 determines 520 that new risk assessment information is available, the method 500 returns and updates 516 supplier selection scores. If the method 500 determines 520 that new risk assessment information is not available, the method 500 again initiates 520 a new search for new risk assessment information, possibly after a time delay. In one example, the data update module 306 initiates 520 a new search for new risk assessment information and determines 520 if there is new risk assessment information. In one embodiment, the method 500 outputs 518 updated selection scores, and the method 500 ends, or possibly returns (not shown) and initiates 520 a new search for new risk assessment information.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a supplier ID module that identifies, as part of a selection process, one or more suppliers that provide a component, the selection process comprising a process to select one or more suppliers to supply the component for use in a product made by a user;
an existing product search module that searches one or more data sources that are available on the internet for one or more existing products purchased by others that one or more of contain the component and comprise the component without other components, the existing products differing from the user's product;
a category module that identifies one or more categories related to the component, each category related to risk assessment for one or more of the component and a supplier of the component;
a component data search module that searches one or more data sources that are available on the internet for risk assessment information related to one or more of the component and existing products with the component and retrieves the risk assessment information, the information relevant to the one or more categories, wherein each item of risk assessment information identifies the supplier that provided the component associated with the item of risk assessment information; and
a categorization module that categorizes the retrieved risk assessment information in the one or more categories,
wherein said modules comprise one or more of hardware and executable code, the executable code stored on one or more computer readable storage media.

2. The apparatus of claim 1, further comprising risk update module that, for each of the one or more suppliers, updates supplier selection information associated with a supplier of the component based on the retrieved risk assessment information.

3. The apparatus of claim 2, wherein the supplier selection information is provided by a supplier selection module that compiles information about each supplier of the one or more suppliers and information about the component supplied by each supplier, the information about each supplier relevant to selecting the supplier for providing the component, the information about the component supplied by each supplier comprising information relevant to selecting the supplier for providing the component.

4. The apparatus of claim 3, wherein the supplier selection module further calculates a supplier selection score for each supplier of the one or more suppliers based on the information about each supplier and the information about the component supplied by each supplier, and the risk update module updates the supplier selection information by adjusting the supplier selection score of each supplier of the one or more suppliers based on the retrieved risk assessment information.

5. The apparatus of claim 3, wherein the information about each supplier and the information about each component comprising one or more of:
information related to component reliability;
information related compliance with a specification for the component;
information related to supplier quality compliance;
information related to supplier performance; and
information related to an ability of the supplier to provide a desired quantity of the component.

6. The apparatus of claim 2, further comprising a data update module that periodically initiates a search for new risk assessment information and retrieves the new risk assessment information wherein the risk update module, for each of the one or more suppliers, updates supplier selection information associated with a supplier of the component based on the new risk assessment information.

7. The apparatus of claim 6, further comprising a supplier adjustment module that one or more of adjusts quantities of the component supplied by selected supplier based on the new risk assessment information and adjusts which suppliers of the one or more suppliers supply the component based on the new risk assessment information.

8. The apparatus of claim 1, wherein the one or more categories comprise categories that facilitate comparison of the one or more suppliers.

9. The apparatus of claim 1, wherein the risk assessment information comprises one or more of:
information about a product recall by a supplier of the one or more suppliers, the recall for a product by the supplier that involves the component;
information about defects of the component;
information about performance of a supplier of the one or more suppliers;
information related to health of a supplier of the one or more suppliers;
information related to customer service of a supplier of the one or more suppliers;
information related to customer satisfaction regarding one or more of the component provided by a supplier of the one or more suppliers and an existing product that includes the component, the existing product provided by a supplier of the one or more suppliers; and
information related to one or more of political instability and a natural disaster that may affect a supplier of the one or more suppliers.

10. The apparatus of claim 1, wherein the component data search module retrieves risk assessment information from one or more social media websites.

11. The apparatus of claim 1, wherein the component data search module uses a web crawler to search information available on the internet.

12. The apparatus of claim 1, wherein the component data search module submits, to one or more search engines, one or more search strings to search information available on the internet, wherein the search engines retrieve the risk assessment information based on previously indexed data.

13. The apparatus of claim 1, wherein each of the one or more suppliers provides a version of the component that complies with one or more component specifications.

14. The apparatus of claim 1, wherein the component data search module receives one or more alerts regarding the component, wherein the one or more alerts comprise risk assessment information.

15. A method comprising:
identifying, using a supplier ID module and as part of a selection process, one or more suppliers that provide a component, the selection process comprising a process to select one or more suppliers to supply the component for use in a product made by a user;
searching, using an existing product search module, one or more data sources that are available on the internet for one or more existing products purchased by others that one or more of contain the component and comprise the component without other components, the existing products differing from the user's product;
identifying, using a category module, one or more categories related to the component, each category related to risk assessment for one or more of the component and a supplier of the component;
searching, using a component data search module, one or more data sources that are available on the internet for risk assessment information related to one or more of the component and existing products with the component and retrieving the risk assessment information, the information relevant to the one or more categories, wherein each item of risk assessment information identifies the supplier that provided the component associated with the item of risk assessment information; and
categorizing, using a categorization module, the retrieved risk assessment information in the one or more categories.

16. The method of claim 15, further comprising compiling, using a supplier selection module, information about each supplier of the one or more suppliers and information about the component supplied by each supplier, the information about each supplier relevant to selecting the supplier for providing the component, the information about the component supplied by each supplier comprising information relevant to selecting the supplier for providing the component, and further comprising updating, using a risk update module and for each of the one or more suppliers, the supplier selection information associated with a supplier of the component based on the retrieved risk assessment information.

17. The method of claim 16, further comprising calculating, using the supplier selection module, a supplier selection score for each supplier of the one or more suppliers based on the information about each supplier and the information about the component supplied by each supplier, and wherein updating the supplier selection information associated with a supplier of the component based on the retrieved risk assessment information further comprises adjusting the supplier selection score of each supplier of the one or more suppliers based on the retrieved risk assessment information.

18. The method of claim 16, further comprising periodically initiating, using a data update module, a search for new risk assessment information and retrieving the new risk assessment information, and further comprising updating, using the risk update module and for each of the one or more suppliers, supplier selection information associated with a supplier of the component based on the new risk assessment information.

19. The method of claim 15, wherein the one or more data sources that are available on the internet for risk assessment information comprise one or more social media websites.

20. A computer program product for supplier risk assessment, the computer program product comprising a computer readable storage medium having program instructions embodied therewith, the program instructions readable/executable by a processor to cause the processor to:
Identify, as part of a selection process, one or more suppliers that provide a component, the selection process comprising a process to select one or more suppliers to supply the component for use in a product made by a user;
search one or more data sources that are available on the internet for one or more existing products purchased by others that one or more of contain the component and comprise the component without other components, the existing products differing from the user's product;
identify one or more categories related to the component, each category related to risk assessment for one or more of the component and a supplier of the component;
search one or more data sources that are available on the internet for risk assessment information related to one or more of the component and existing products with the component and retrieving the risk assessment information, the information relevant to the one or more categories, wherein each item of risk assessment information identifies the supplier that provided the component associated with the item of risk assessment information; and
categorize the retrieved risk assessment information in the one or more categories.
